(19) United States
(12) Patent Application Publication
(10) Pub. No.: US 2013/0091017 A1
(43) Pub. Date: Apr. 11, 2013

(54) Method And System for User Connections and Advertising Using Geographic Index of Affinity

(71) Applicants: Brian Mullin, Woodland, CA (US); Jessie Ivey, Woodland, CA (US)

(72) Inventors: Brian Mullin, Oakland, CA (US); Jessie Ivey, Oakland, CA (US)

(73) Assignee: DugaDuga.com, Inc., Woodland, CA (US)

(21) Appl. No.: 13/633,001

(22) Filed: Oct. 1, 2012

Related U.S. Application Data
(60) Provisional application No. 61/543,692, filed on Oct. 5, 2011.

(51) Int. Cl. H04L 29/06

(52) U.S. Cl. CPC H04L 65/403
USPC 705/14.58; 709/204

(57) ABSTRACT

A system for managing a geographic index of affinity (GIA), defined as a distance a user is willing to find/connect with other users, specific to a particular shared interest. The GIA includes a degree of distance (Affinity) based on their geographic location and can be used in conjunction with free online Web services to deliver a steady and relevant pool of meaningful connections based on interest-specific GIAs. This provides an advantage of capitalizing on blind spots and shortfalls in current social networking platforms by building sites where users build communities of trust, and, in the process, make themselves open to relevant local advertising. As desired, user demographic databases are built that include specific interests, approximate location, age and gender of the users using the GIA.

### CROSS-REFERENCE TO RELATED APPLICATIONS

This application claims the benefit of U.S. Provisional Application No. 61/543,692 filed Oct. 5, 2011, which application is incorporated herein by reference.

### FIELD

The present method and system relate generally to software applications and, more particularly, to user connections and advertising using a geographic index of affinity.

### BACKGROUND

Online advertising is a form of promotion that uses the Internet and World Wide Web to deliver marketing messages to attract customers. Examples of online advertising include contextual ads on search engine results pages, banner ads, Rich Media Ads, Social network advertising, interstitial ads, online classified advertising, advertising networks and e-mail marketing, including e-mail spam. Many of these types of ads are delivered by an Ad server.

### SUMMARY

The present system includes a geographic index of affinity (GIA), and a GIA is defined as how far from a user that user is willing to find or connect with other users specific to a particular shared interest. The GIA allows users to set a degree of distance (Affinity) based on their geographic location. The closer a user is to another, the stronger their GIA and potential connection with them. The GIA is used in conjunction with free online web services to deliver a steady and relevant pool of meaningful connections to a user based on the interest-specific GIA they have set.

The present system capitalizes on blind spots and shortfalls offered in current social networking and media sites by building various sites where users build communities of trust, and, in the process, make themselves open to relevant local advertising. Rather than selling keywords, as is the norm in the online advertising market, the present system provides access for small business advertisers to a very relevant customer base by allowing them to advertise to select demographically and geographically interest-specific categories of user communities. Using a geographic index of affinity (GIA) user demographic databases are built that include specific interests, approximate location, age and gender of the users. The database offers targeted small business advertising to highly interested, potential customers in a social networking and media context where users are receptive to trusted, local advertising content.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

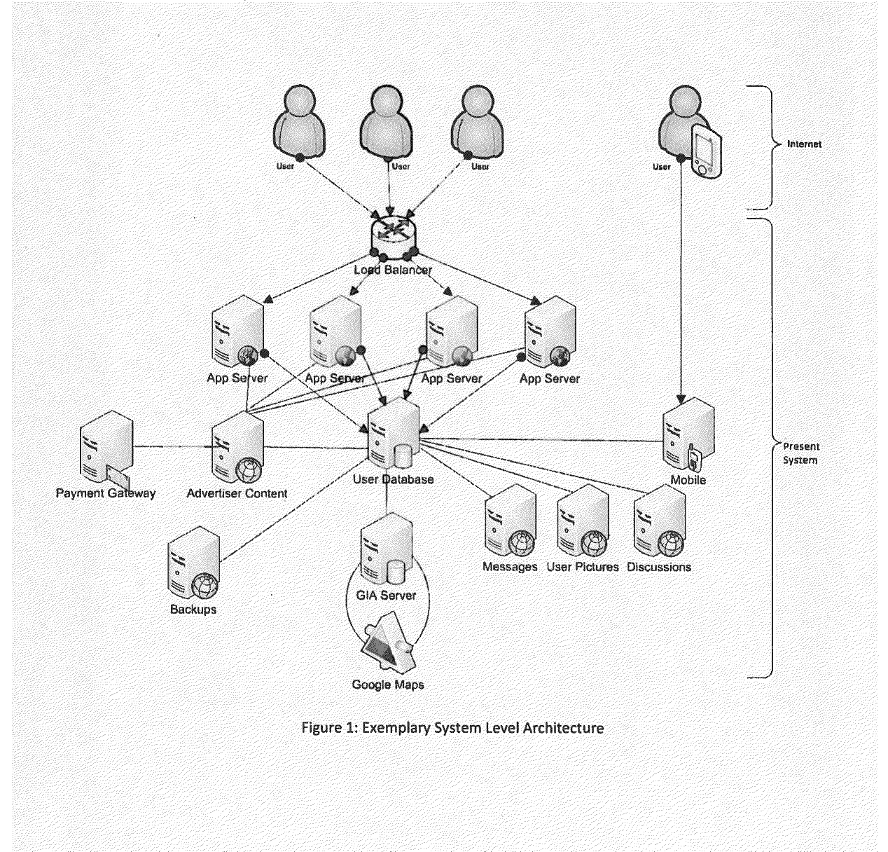

FIG. 1 illustrates an exemplary system level layout for use with the present system, according to one embodiment.

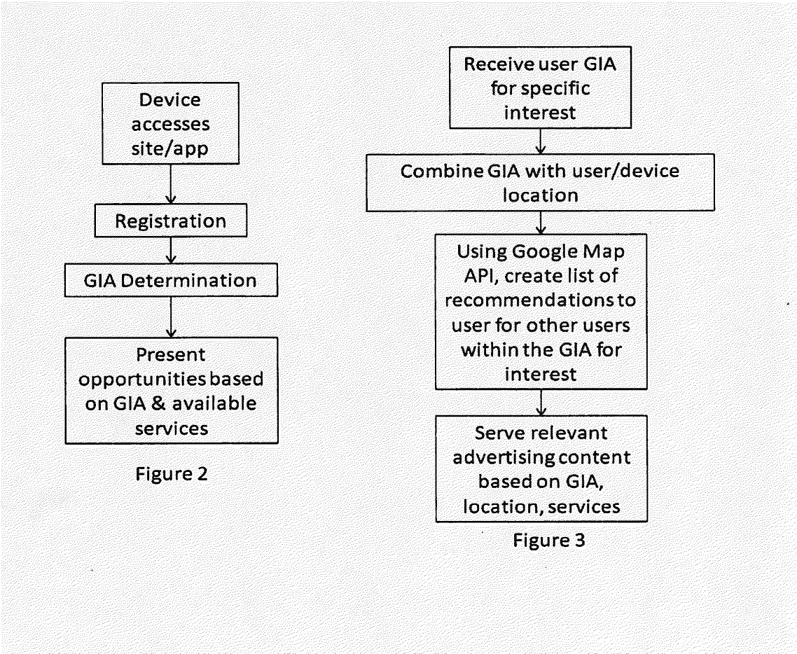

FIG. 2 illustrates an exemplary registration process for use with the present system, according to one embodiment.

FIG. 3 illustrates an exemplary content serving process for use with the present system, according to one embodiment.

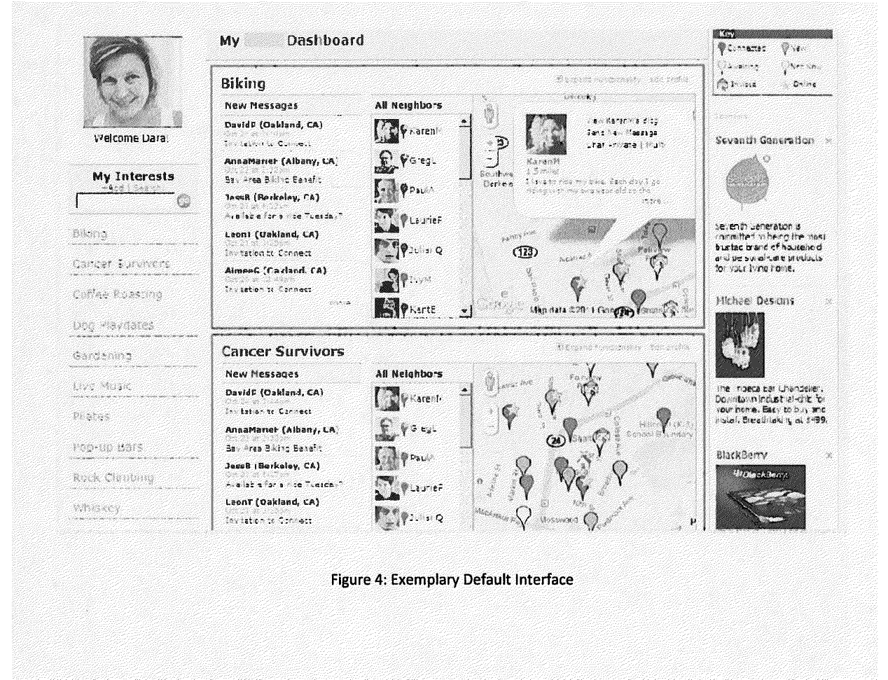

FIG. 4 illustrates an exemplary default interface for use with the present system, according to one embodiment.

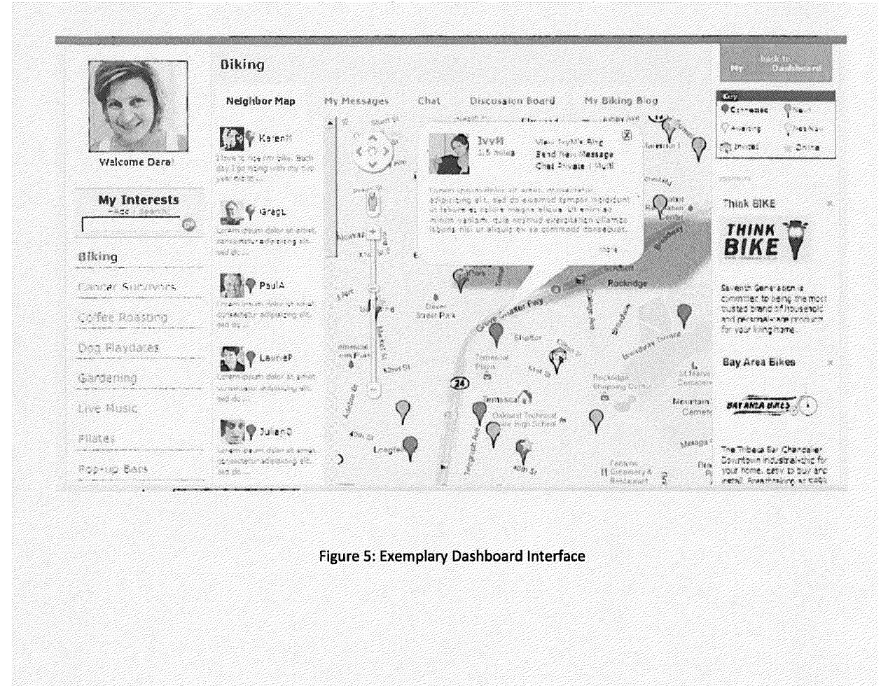

FIG. 5 illustrates an exemplary dashboard interface for use with the present system, according to one embodiment.

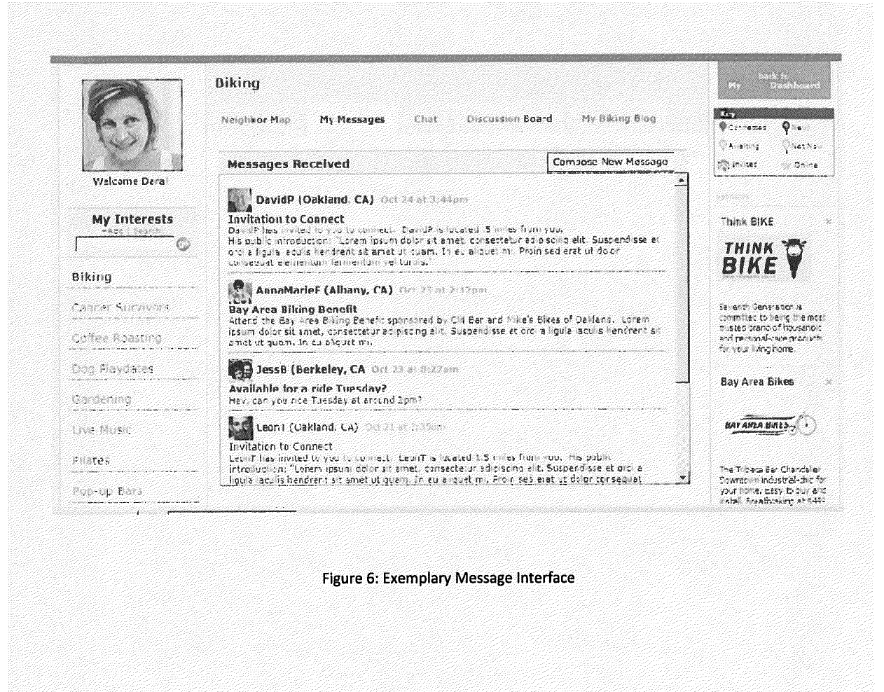

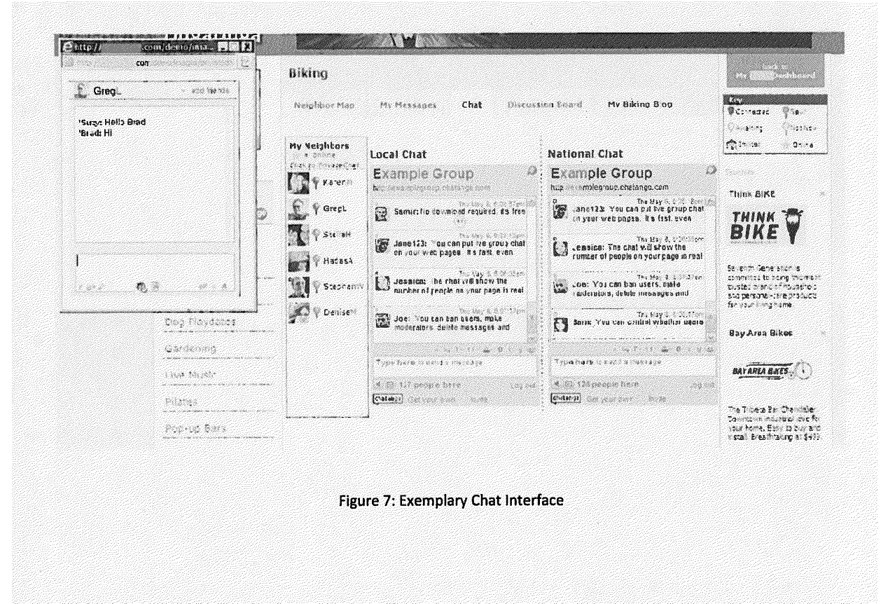

FIG. 6 illustrates an exemplary message interface for use with the present system, according to one embodiment.

FIG. 7 illustrates an exemplary chat interface for use with the present system, according to one embodiment.

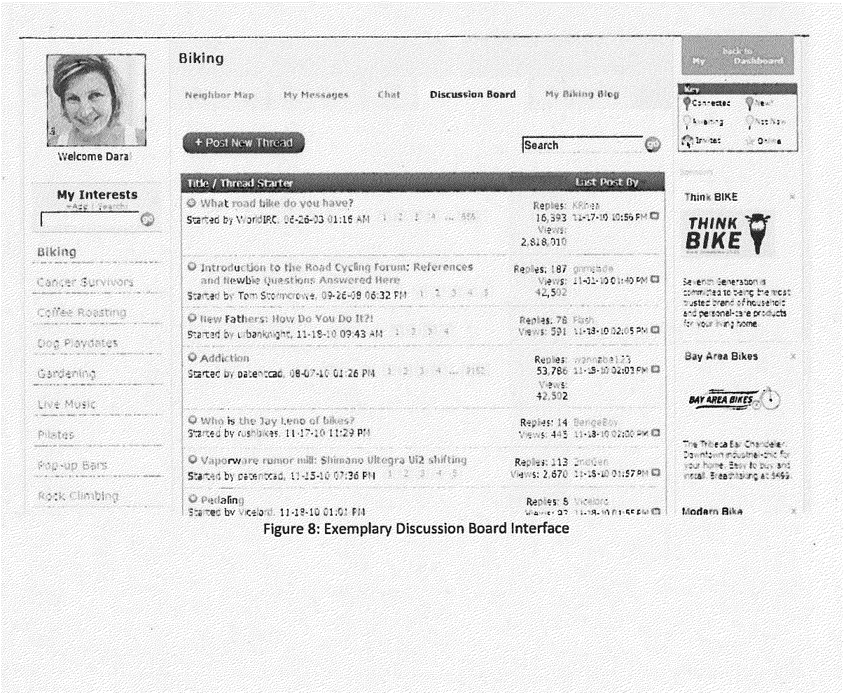

FIG. 8 illustrates an exemplary discussion board interface for use with the present system, according to one embodiment.

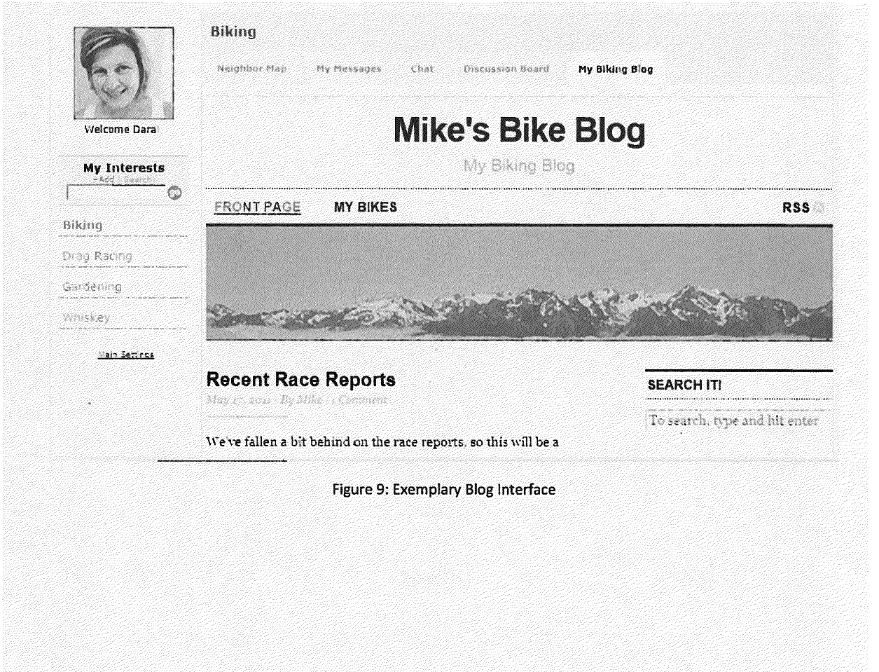

FIG. 9 illustrates an exemplary blog interface for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

According to one embodiment, a geographic index of affinity (GIA) is defined as how far from a user that user is willing to find or connect with other users specific to a particular shared interest. User engagement and openness to activities of a particular type tends to vary based on proximity unique to that specific interest (e.g. a user generally only wants to share a cup of sugar with a neighbor, but would be willing to connect with fellow knitters or bikers within a 20 mile radius). The GIA allows users to set a degree of distance (Affinity) based on their geographic location. The closer a user is to another, the stronger their GIA and potential connection with them. The GIA is used in conjunction with free online web services to deliver a steady and relevant pool of meaningful connections to a user based on the interest-specific GIA they have set.

According to one embodiment, the interest-specific information collected from users to create GIA's is used to solicit small businesses that are typically priced out by the conventional online advertising providers. Small businesses are provided with aggregated demographic and geographically targeted customer pools close to their businesses (based on the GIA technology), and, from this, they can purchase highly targeted and customized advertising placement. Advertisers selectively present themselves to users with specific demographic and location characteristics chosen by the advertiser. In this context, users have a high degree of affinity for their offerings. This delivers engaged, loyal and highly interested customers.

FIG. 1 illustrates an exemplary system level layout for use with the present system, according to one embodiment. According to one embodiment, a website for use with the present system is hosted by a series of application servers that users connect to by logging into their account. Application servers connect to a central user database that contains their login information, zip code, nearest intersection, interests and GIA preferences. Advertising content, user messages, profile pictures, and discussion content are be stored on other respective servers that pass data back to the application server and on to the user device's web browser. Mobile devices have an application service route accessing the central database with the same basic set of features available to traditional web browser sessions. Behind the central database is a GIA server. The GIA server takes each user's GIA preference for each of their interests and combines it with their general location, then uses Google's Mapping APIs to create a list of recommendations to that user for other users within their GIA for each of their interests.

It is noted that the present system is accessible via any web browser on any network connected computing device.

FIG. 2 illustrates an exemplary registration process for use with the present system, according to one embodiment. A user device accesses a website or mobile application according to the present system and provides registration information.

Registration information includes the user's month and year of birth, gender, picture, nearest major intersection (which is converted by into longitude and latitude coordinates), zip code, their interests, and how far from their intersection they would like to connect with others on that specific interest. All of the registration information is stored along with a blog URL for each interest that a user is following and eventually email messages they send to other users by each interest grouping. Users can also store links to other resources online (video, photos, content) from other 3rd party service providers.

According to one embodiment, the present system performs a search using the GIA as a radius and using the user's originating longitude and latitude coordinates as the center point. Using the Haversine formula, the present system calculates a “zone” over a spherical area (earth) that corresponds to the radius designated by the user. Any user in the zone for a particular interest is a candidate for connection for each interest.

The present system presents the user with other users relevant to each of their GIA-specific interests. When a user sees another user in their GIA for a particular interest, they are able to immediately send each other a message to connect. Users who have agreed to connect are then able to send messages to each other on the sites using our internal messaging space similar to internal email. The summary and individual connect and communication messages trigger delivery of an email to the user's outside email account or mobile device.

Users are presented with updated summaries via email and upon subsequent logins. If the user is offline, the connection recommendation data is passed back to the central database awaiting the user's next login and will be rendered in their dashboard map for each of their interests. If the user is online, when a new user posts within their GIA, that new user appears within seconds on the dashboard map in order for the two to connect.

FIG. 3 illustrates an exemplary content serving process for use with the present system, according to one embodiment. In addition to the GIA determination and presenting of opportunities/users to a user described with regard to FIG. 2, relevant advertising content is served to the user. Relevant information is delivered in aggregated form. For example, reports can show the top 10 interests for a certain 50 mile radius from a location. Those top 10 or more interests are broken down into demographic information about the population of users sharing their interests to target specific small businesses catering to those interests. As another example, a report for Topeka indicates that bicycling is the top interest within 25 miles of Topeka. The age and gender distribution of registered users in bicycling can then be obtained. This aggregated demographic information enables bicycling shops in Topeka to advertise to a captive/opted-in interest group geographically close to and specific to their small business' product offerings.

FIG. 4 illustrates an exemplary default interface for use with the present system, according to one embodiment. Upon logging into the present system, users are presented with a default main interface.

FIG. 5 illustrates an exemplary dashboard interface for use with the present system, according to one embodiment. In this example, a first tab is presented where users see their neighbor map. The neighbor map presents them with users near them for this specific interest, and displays whether those users are new, connected, awaiting connection, invited, online, or “not now” meaning given a pass but not gone forever from the community. Users have the ability to perform searches in the neighbor map, allowing them to locate users anywhere in the nation to connect with who share their interest (e.g. if the user is traveling or looking to expand their social network).

Users have dashboards unique for each of their interests as the content and advertisements presented are specific to each interest. In this example the interest is biking. Advertising for interest-specific businesses appear at the leaderboard (top) of the page for a wide area, while advertising on the skyscraper (right-hand side) is for interest-specific businesses who want to target a specific demographic and geographic radius. For example, a national bike maker can advertise on the leaderboard (top) of anyone in the country clicking into their biking dashboard in the example provided, while the skyscraper (right side) on the same page is for small businesses local to 5-10 miles of the user's home intersection depending on the criteria of the advertiser. In the example provided, advertisers in the skyscraper have selected to only be presented to users for the “Biking” interest who meet their demographic and geographic (within 5-10 miles) criteria. Advertisers pay to present to people within their target distance from their store(s) and who meet their demographic customer acquisition goals, and only for the interests those businesses choose.

FIG. 6 illustrates an exemplary message interface for use with the present system, according to one embodiment. Users are presented with messages they have sent to and received from other users in their interest.

FIG. 7 illustrates an exemplary chat interface for use with the present system, according to one embodiment. Users can have private one-on-one or group chats with others in their GIA or neighbor map. They may also chat publicly in a local chat with other users in their GIA or neighbor map. They may also chat will any other users in the country in their interest.

FIG. 8 illustrates an exemplary discussion board interface for use with the present system, according to one embodiment. Users are able open and respond to discussion forums throughout the country, or just within their GIA/neighborhood.

FIG. 9 illustrates an exemplary blog interface for use with the present system, according to one embodiment. Users are able to interact and read a blog of their choice for each of their interests. By keeping the third party blog experience framed in the dashboard, users are still exposed to advertising and able to navigate the other tabs of this interest and switch to other interests.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general-purpose systems, computer servers, or personal computers may be used with programs in accordance with the teachings herein, or it may prove convenient to construct a more specialized apparatus to perform the required method steps. The required structure for a variety of these systems will appear from the description above. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

A system and method for user connections and online advertising using a geographic index of affinity have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A computer-implemented method, comprising:
receiving user input from a user device, the user input comprising and intersection, an interest, and an interest radius for a first user;
calculating a geographic index of affinity by using the intersection, interest, and interest radius;
calculating a zone corresponding to the interest by using the geographic index of affinity;
locating a second user in the zone corresponding to the interest;
displaying information related to the second user to the user device; and
providing for communication between the first user and the second user.

2. The computer-implemented method of claim 1, further comprising retrieving and displaying advertising content to the user device based on the geographic index of affinity and available services.

3. The computer-implemented method of claim 1, wherein the interest radius represents a distance from the intersection associated with the interest.

4. The computer-implemented method of claim 1, further comprising storing a blog URL for the interest.

5. The computer-implemented method of claim 1, further comprising converting the intersection to longitude and latitude coordinates.

6. The computer-implemented method of claim 1, wherein calculating the zone uses a Haversine formula.

7. The computer-implemented method of claim 1, wherein the user input further comprises a birth month, a birth year, a gender, a picture, and a zip code for the first user.

8. A non-transitory computer-readable medium having stored thereon a plurality of instructions, the instructions when executed by a processor cause the processor to perform:
receiving user input from a user device, the user input comprising and intersection, an interest, and an interest radius for a first user;
calculating a geographic index of affinity by using the intersection, interest, and interest radius;
calculating a zone corresponding to the interest by using the geographic index of affinity;
locating a second user in the zone corresponding to the interest;
displaying information related to the second user to the user device; and
providing for communication between the first user and the second user.

9. The non-transitory computer-readable medium of claim 8, further causing the processor to perform retrieving and displaying advertising content to the user device based on the geographic index of affinity and available services.

10. The non-transitory computer-readable medium of claim 8, wherein the interest radius represents a distance from the intersection associated with the interest.

11. The non-transitory computer-readable medium of claim 8, further causing the processor to perform storing a blog URL for the interest.

12. The non-transitory computer-readable medium of claim 8, further causing the processor to perform converting the intersection to longitude and latitude coordinates.

13. The non-transitory computer-readable medium of claim 8, wherein calculating the zone uses a Haversine formula.

14. The non-transitory computer-readable medium of claim 8, wherein the user input further comprises a birth month, a birth year, a gender, a picture, and a zip code for the first user.

15. A system, comprising:
a server in communication with a network; and
software instructions stored on the server and executable by the server, the software instructions for:
receiving user input from a user device, the user input comprising and intersection, an interest, and an interest radius for a first user;
calculating a geographic index of affinity by using the intersection, interest, and interest radius;
calculating a zone corresponding to the interest by using the geographic index of affinity;
locating a second user in the zone corresponding to the interest;
displaying information related to the second user to the user device; and
providing for communication between the first user and the second user.

16. The system of claim 15, further comprising retrieving and displaying advertising content to the user device based on the geographic index of affinity and available services.

17. The system of claim 15, wherein the interest radius represents a distance from the intersection associated with the interest.

18. The system of claim 15, further comprising storing a blog URL for the interest.

19. The system of claim 15, further comprising converting the intersection to longitude and latitude coordinates.

20. The system of claim 15, wherein calculating the zone uses a Haversine formula.

21. The system of claim 15, wherein the user input further comprises a birth month, a birth year, a gender, a picture, and a zip code for the first user.
